(19) United States
(12) Patent Application Publication
(10) Pub. No.: US 2016/0136680 A1
(43) Pub. Date: May 19, 2016

(54) COATING DEVICE AND COATING METHOD

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Lei HUO, Beijing (CN); Feifei SUN, Beijing (CN)

(73) Assignees: BEIJING BOE OPTOELECTRONICS TECHNOLOGY CO., LTD., Beijing (CN); BOE TECHNOLOGY GROUP CO., LTD., Beijing (CN)

(21) Appl. No.: 14/748,842

(22) Filed: Jun. 24, 2015

(30) Foreign Application Priority Data
Nov. 19, 2014 (CN) 201410664773.X

(51) Int. Cl. B05D 1/02; B05B 12/02

(52) U.S. Cl. CPC B05D 1/02; B05B 12/02

(57) ABSTRACT

Embodiments of the present invention disclose a coating device and a coating method. The coating device comprises: a vacuum working chamber, with a substrate to be coated arranged in the vacuum working chamber; and a nozzle, configured to coat a coating material on the substrate and arranged in the vacuum working chamber.

### TECHNICAL FIELD

Embodiments of the invention relate to a coating device and a coating method.

### BACKGROUND

In a process of fabricating a display panel, a sliver paste is coated at a specific edge position of the display panel formed by cell-assembling an array substrate and a color filter substrate, so that static electricity generated by the color filter substrate can be leaded to a grounding region of the array substrate, thereby preventing the static electricity from influencing the display effect of the display panel.

Usually, a commonly-used silver paste coating device coats the sliver paste on a substrate via a sliver paste nozzle; however, in a process of coating the silver paste, because the sliver paste in the sliver paste nozzle is easily cured under environmental influence, and a diameter of the silver paste nozzle is very small, the silver paste nozzle may be easily blocked such that the silver paste is coated poorly, thereby affecting the display effect of the display panel.

### SUMMARY OF THE INVENTION

Embodiments of the present invention provide a coating device and a coating method, which can prevent a nozzle from being blocked, making a coating material coated well.

On one hand, an embodiment of the present invention provides a coating device, comprising: a vacuum working chamber, with a substrate to be coated being arranged in the vacuum working chamber; and a nozzle, configured to coat a coating material on the substrate and arranged in the vacuum working chamber.

On the other hand, an embodiment of the present invention provides a coating method using the coating device as described above, comprising: placing a substrate in the vacuum working chamber, and coating a coating material on the substrate by the nozzle.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a structural schematic diagram of a coating device;

FIG. 2 is a structural schematic diagram of a coating device according to an embodiment of the present invention;

FIG. 3 is a structural schematic diagram of a continuous positioning unit according to an embodiment of the present invention; and

FIG. 4 is a structural schematic diagram of another coating device according to an embodiment of the present invention.

### DESCRIPTION OF THE EMBODIMENTS

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

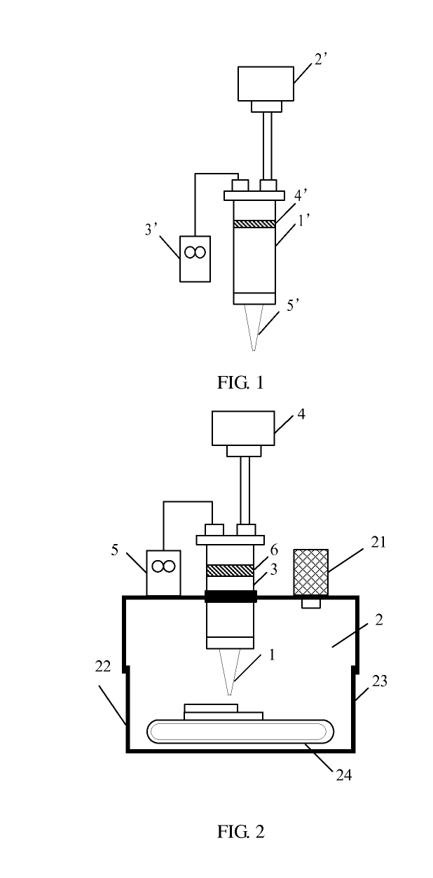

FIG. 1 shows a coating device, comprising a silver paste storage unit 1′, a power cylinder 2′, an air pressure controller 3′, a sliver paste storage unit piston 4′ and a silver paste nozzle 5′. Herein, the power cylinder 2′ is disposed on top of the silver paste storage unit 1′, for lowering the silver paste storage unit 1′ to a coating position before coating; the air pressure controller 3′ is communicated with the silver paste storage unit 1′, for driving the sliver paste storage unit piston 4′ disposed inside the silver paste storage unit 1′, so that sliver paste is ejected from the silver paste nozzle 5′ on bottom of the silver paste storage unit 1′.

### A First Embodiment

The embodiment of the present invention provides a coating device; the coating device is used for coating a coating material on a substrate, and the above-mentioned coating material may be a coating material which is easily cured under environmental influence such as air, moisture and so on, for example, a sliver paste, which will not be specifically limited by the embodiment of the present invention; the above-mentioned substrate may be a display panel, or may be a substrate of any other type.

As shown in FIG. 2, the coating device comprises a nozzle 1 and a vacuum working chamber 2, wherein, the nozzle 1 is arranged in the vacuum working chamber 2.

When a coating material is coated on a substrate by the coating device, because the nozzle 1 is arranged in the vacuum working chamber 2, the coating material in the nozzle 1 will not be cured under the influence of air and moisture, thus preventing the nozzle 1 from being blocked, making the coating material coated well; and furthermore, when the coating material is a sliver paste, and the substrate is a display panel, well coating of the sliver paste well can improve the display effect of the display panel and prevent a failure of the coating device caused by blocking the nozzle 1.

An exemplary structure of the coating device is given as follows.

As shown in FIG. 2, the vacuum working chamber 2 includes a vacuum generator 21 located on top of the vacuum working chamber 2. The vacuum generator 21 may vacuumize the vacuum working chamber 2 to make the vacuum working chamber 2 reach a certain vacuum degree, which may be in a range from −0.5 to −1.0 standard atmosphere, for exand make the vacuum working chamber 2 keep a vacuum state, so that the coating material in the nozzle 1 is not cured under the influence of air and moisture, thus preventing the nozzle 1 from being blocked.

Herein, the vacuum degree may be in a range from −0.5 to −1.0 standard atmosphere, such as, −0.6, −0.7, −0.8 or −0.9 standard atmosphere.

Further, the vacuum working chamber 2 further includes a first port 22 and a second port 23 located on both sides of the vacuum working chamber 2, for easily conveying the substrate.

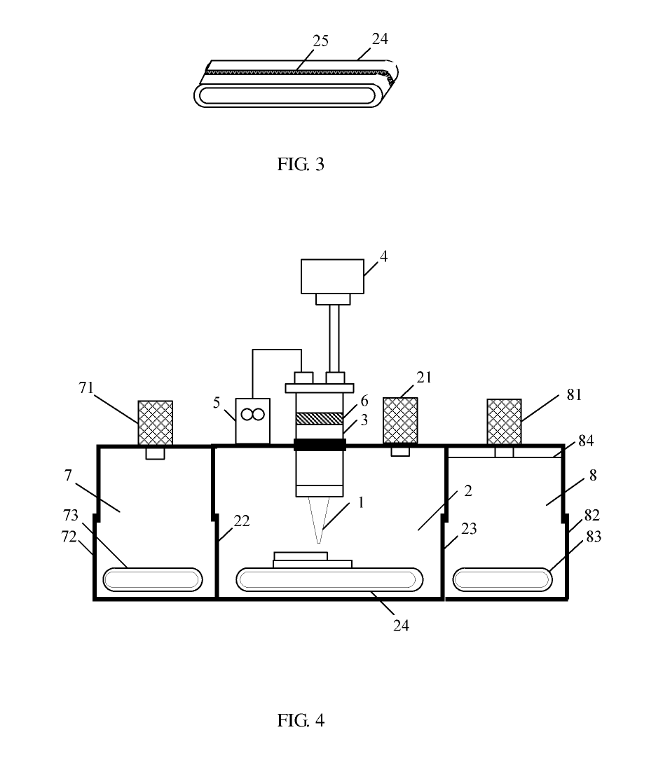

Further, the vacuum working chamber 2 further includes a conveying structure 24 located on bottom of the vacuum working chamber 2. The conveying structure 24 realizes an automated conveying for the substrate, thus reducing manual operation. The conveying structure 24 may be a conveyor belt, or may be other structures that can convey the substrate. Furthermore, as shown in FIG. 3, the vacuum working chamber 2 may further include a continuous positioning unit 25 arranged on the conveying structure 24, the continuous positioning unit 25 is disposed on the conveying structure 24 in a straight line along a conveying direction of the conveying structure 24, making the substrate not moved left or right, and ensuring the substrate to be precisely positioned.

Furthermore, as shown in FIG. 4, the coating device further comprises: a storage unit 3, a power cylinder 4, an air pressure controller 5 and a storage unit piston 6. Wherein, a part of the storage unit 3 is arranged in the vacuum working chamber 2, the power cylinder 4 is arranged on top of the storage unit 3, the air pressure controller 5 is arranged on top of the vacuum working chamber 2, and the storage unit piston 6 is arranged in the storage unit 3.

Optionally, as shown in FIG. 4, the coating device further comprises a loading vacuum chamber 7 and an unloading vacuum chamber 8 respectively located on both sides of the vacuum working chamber 2, the loading vacuum chamber 7 being communicated with the vacuum working chamber 2 via the first port 22, the unloading vacuum chamber 8 being communicated with the vacuum working chamber 2 via the second port 23. Because the loading vacuum chamber 7 is in a vacuum state, when the first port 22 of the vacuum working chamber 2 is opened, an inside of the vacuum working chamber 2 is still kept in a vacuum state; similarly, because the unloading vacuum chamber 8 is in a vacuum state, when the second port 23 of the vacuum working chamber 2 is opened, an inside of the vacuum working chamber 2 is still kept in a vacuum state. It can be seen that, if the loading vacuum chamber 7 and the unloading vacuum chamber 8 are placed on both sides of the vacuum working chamber 2, it can be ensured that the vacuum working chamber 2 is always kept in a vacuum state when the ports on both sides of the vacuum working chamber 2 are opened, thereby avoiding repeated vacuumization for the vacuum working chamber 2.

Exemplary structures of the loading vacuum chamber 7 and the unloading vacuum chamber 8 are described as follows.

As shown in FIG. 4, the loading vacuum chamber 7 includes a vacuum generator 71 located on top of the loading vacuum chamber 7, and the unloading vacuum chamber 8 includes a vacuum generator 81 located on top of the unloading vacuum chamber 8. The vacuum generator 71 can make the loading vacuum chamber 7 be in a vacuum state, while the vacuum generator 81 can make the unloading vacuum chamber 8 be in a vacuum state.

Further, the loading vacuum chamber 7 further includes a third port 72 disposed opposite to the first port 22, and the unloading vacuum chamber 8 further includes a fourth port 82 disposed opposite to the second port 23; and the substrate may be more easily conveyed by laterally disposing the port.

Further, the loading vacuum chamber 7 further includes a conveying structure 73 located on bottom of the loading vacuum chamber 7, and the unloading vacuum chamber 8 further includes a conveying structure 83 located on bottom of the unloading vacuum chamber 8. Wherein, the conveying structure 73 and the conveying structure 83 can realize an automated conveying for the substrate, thus reducing manual operation. The conveying structure 73 and the conveying structure 83 may be conveyor belts, or may be other structures that can convey the substrate. Furthermore, the loading vacuum chamber 7 may further include a continuous positioning unit arranged on the conveying structure 73, and the continuous positioning unit of the loading vacuum chamber 7 is disposed on the conveying structure 73 in a straight line along a conveying direction of the conveying structure 73, making the substrate not moved left or right, and ensuring the substrate to be precisely positioned. Similarly, the unloading vacuum chamber 8 further includes a continuous positioning unit arranged on the conveying structure 83, and the continuous positioning unit of the unloading vacuum chamber 8 is disposed on the conveying structure 83 in a straight line along a conveying direction of the conveying structure 83, making the substrate not moved left or right, and ensuring the substrate to be precisely positioned. The arrangement of the continuous positioning units of the loading vacuum chamber 7 and the unloading vacuum chamber 8 may refer to the arrangement of the continuous positioning unit 25 of the vacuum working chamber 2 as shown in FIG. 3.

Further, the unloading vacuum chamber 8 further includes a curing structure 84. The curing structure 84 may be selected according to the coating material, for example, when the coating material is a sliver paste, the curing structure 84 may be an infrared light wave emitter, and an infrared light wave of the infrared light wave emitter can cure the sliver paste coated on the substrate.

The embodiment of the present invention provides a coating device, the coating device comprising a nozzle and a vacuum working chamber, and the nozzle being arranged in the vacuum working chamber. It can be seen that, the coating material in the nozzle will not be influenced by air and moisture and thus not be cured, so as to prevent the nozzle from being blocked, and well coat the coating material; and furthermore, when the coating material is a sliver paste, and the substrate is a display panel, the display effect of the display panel can be improved by coating the sliver paste well.

### A Second Embodiment

The embodiment of the present invention further provides a coating method implemented by using the coating device described in the first embodiment, the coating method is described as follows in conjunction with the coating device in FIG. 4, and the coating method comprises:

Placing a substrate in the vacuum working chamber 2, and coating a coating material on the substrate by the nozzle 1.

Wherein, a process of coating the coating material on the substrate by the nozzle 1 is that: lowering the storage unit 3 to a coating position under the action of the power cylinder 4, driving the storage unit piston 6 in the storage unit 3 by the air pressure controller 5, so that the coating material is ejected from the nozzle 1, so as to coat the coating material on the substrate.

Optionally, before the placing the substrate in the vacuum working chamber 2 and coating a coating material on the substrate by the nozzle 1, the coating method further comprises:

Opening vacuum generators of the loading vacuum chamber 7, the vacuum working chamber 2 and the unloading vacuum chamber 8;

Closing the vacuum generator 71 of the loading vacuum chamber 7, opening a third port 72, and placing the substrate on a conveying structure 73 in the loading vacuum chamber 7;

Closing the third port 72, and opening the vacuum generator 71 of the loading vacuum chamber 7;

Opening a first port 22, conveying the substrate into the vacuum working chamber 2 by the conveying structure 73 in the loading vacuum chamber 7, and closing the first port 22.

Optionally, after the placing the substrate in the vacuum working chamber 2 and coating a coating material on the substrate by the nozzle 1, the coating method further comprises:

Opening the second port 23, and conveying the substrate into the unloading vacuum chamber 8 by a conveying structure 24 in the vacuum working chamber 2;

Closing the second port 23, and opening a curing structure 84, to cure a coating material coated on the substrate by the curing structure 84;

Closing the curing structure 84, and closing a vacuum generator 81 in the unloading vacuum chamber 8;

Opening a fourth port 82, conveying the substrate to an outside of the unloading vacuum chamber 8 by a conveying structure 83 in the unloading vacuum chamber 8, and closing the fourth port 82.

The coating material can be coated on a substrate by the above steps; when it is necessary to coat the coating material on a plurality of substrates, respectively, the above steps should be repeated to complete the coating. It should be noted that, due to the arrangement of the loading vacuum chamber 7 and the unloading vacuum chamber 8, in the process of repeating the above steps, it is not necessary to repeatedly vacuumize the vacuum working chamber 2, so in the embodiments of the present invention, the vacuum generator 21 of the vacuum working chamber 2 may be closed after coating the coating material on all substrates; or the vacuum generator 21 may be closed before coating and after vacuumizing the vacuum working chamber 2; at this moment, energy consumption of the coating device can be reduced and the costs can be saved.

Embodiments of the present invention provide a coating method, the coating method comprising: placing a substrate in the vacuum working chamber 2, and coating a coating material on the substrate by the nozzle 1. Because the nozzle is arranged in the vacuum working chamber, the coating material in the nozzle will not be influenced by air and moisture and not be cured, so as to prevent the nozzle from being blocked, and well coat the coating material; and furthermore, when the coating material is a sliver paste, and the substrate is a display panel, the display effect of the display panel can be improved by coating the sliver paste well.

The above are only specific embodiments of the present invention, but the scope of the invention is not limited thereto, and any skilled in the art, within the technical scope disclosed by the invention, can easily think of variations or replacements, which should be covered within the protection scope of the invention. Therefore, the scope of the present invention should be the scope of the following claims.

The application claims priority to the Chinese patent application No. 201410664773.X filed on Nov. 19, 2014, which is incorporated herein by reference in its entirety.

What is claimed is:

1. A coating device, comprising:
a vacuum working chamber, with a substrate to be coated being disposed in the vacuum working chamber; and
a nozzle, configured to coat a coating material on the substrate and disposed in the vacuum working chamber.

2. The coating device according to claim 1, wherein the vacuum working chamber comprises a vacuum generator located on top of the vacuum working chamber.

3. The coating device according to claim 2, wherein the vacuum working chamber further comprises a first port and a second port located on both sides of the vacuum working chamber.

4. The coating device according to claim 3, wherein the vacuum working chamber further comprises a conveying structure located on bottom of the vacuum working chamber, and the conveying structure is configured to convey the substrate to be coated.

5. The coating device according to claim 4, wherein the coating device further comprises a loading vacuum chamber and an unloading vacuum chamber respectively located on both sides of the vacuum working chamber, the loading vacuum chamber being communicated with the vacuum working chamber via the first port, and the unloading vacuum chamber being communicated with the vacuum working chamber via the second port.

6. The coating device according to claim 5, wherein the loading vacuum chamber comprises a vacuum generator located on top of the loading vacuum chamber, and the unloading vacuum chamber comprises a vacuum generator located on top of the unloading vacuum chamber.

7. The coating device according to claim 6, wherein the loading vacuum chamber further comprises a third port disposed opposite to the first port, and the unloading vacuum chamber further comprises a fourth port disposed opposite to the second port.

8. The coating device according to claim 7, wherein the loading vacuum chamber further comprises a conveying structure located on bottom of the loading vacuum chamber, and the unloading vacuum chamber further comprises a conveying structure located on bottom of the unloading vacuum chamber.

9. The coating device according to claim 8, wherein the unloading vacuum chamber further comprises a curing structure and the curing structure is configured to cure the coating material.

10. The coating device according to claim 1, further comprising: a storage unit, configured to store the coating material, wherein a part of the storage unit is disposed in the vacuum working chamber and the nozzle is connected to an end of the part of the storage unit.

11. The coating device according to claim 10, further comprising: a power unit, located on top of the storage unit and configured to change a position of the end of the storage unit connected with the nozzle.

12. The coating device according to claim 10, further comprising:
a storage unit piston, located in the storage unit; and
an air pressure controller, configured to drive the storage unit piston.

13. A coating method using the coating device according to claim 1, comprising:
placing a substrate in the vacuum working chamber, and coating a coating material on the substrate by the nozzle.

14. The coating method according to claim 13, wherein the vacuum working chamber further comprises a first port and a second port located on both sides of the vacuum working chamber, and the coating device further comprises a loading vacuum chamber and an unloading vacuum chamber respectively located on both sides of the vacuum working chamber, the loading vacuum chamber being communicated with the vacuum working chamber via the first port, and the unloading vacuum chamber being communicated with the vacuum working chamber via the second port; before the placing a substrate in the vacuum working chamber and coating a coating material on the substrate by the nozzle, the coating method further comprises:
opening vacuum generators of the loading vacuum chamber, the vacuum working chamber and the unloading vacuum chamber;
closing the vacuum generator of the loading vacuum chamber, opening a third port, and placing the substrate on a conveying structure in the loading vacuum chamber;
closing the third port, and opening the vacuum generator of the loading vacuum chamber;
opening the first port, conveying the substrate into the vacuum working chamber by the conveying structure in the loading vacuum chamber, and closing the first port.

15. The coating method according to claim 14, after the placing a substrate in the vacuum working chamber and coating a coating material on the substrate by the nozzle, further comprising:
opening the second port, and conveying the substrate into the unloading vacuum chamber by a conveying structure in the vacuum working chamber;
closing the second port, and opening a curing structure, to cure a coating material coated on the substrate by the curing structure;
closing the curing structure, and closing the vacuum generator in the unloading vacuum chamber; and
opening a fourth port, conveying the substrate to an outside of the unloading vacuum chamber by a conveying structure in the unloading vacuum chamber, and closing the fourth port.

16. The coating method according to claim 14, wherein the coating device further comprises: a storage unit, configured to store the coating material and a part of the storage unit located in the vacuum working chamber; a power unit, located on top of the storage unit and configured to change a position of an end of the storage unit connected with the nozzle, wherein the nozzle is connected to an end of the part of the storage unit located in the vacuum working chamber, wherein after the closing the first port and before the coating a coating material on the substrate by the nozzle, the coating method further comprises: lowering the nozzle to a coating position by using the power unit.

17. The coating method according to claim 16, wherein the coating device further comprises: a storage unit piston, located in the storage unit; an air pressure controller, configured to drive the storage unit piston, wherein the coating a coating material on the substrate by the nozzle comprises: driving the storage unit piston by the air pressure controller to eject the coating material from the nozzle.
